(19) United States
(12) Patent Application Publication
(10) Pub. No.: US 2008/0126213 A1
(43) Pub. Date: May 29, 2008

(54) PEER-TO-PEER DATA REPLICATION FOR OFF-LINE TRANSACTIONS IN A RETAIL FUELING ENVIRONMENT

(75) Inventors: Philip A. Robertson, Greensboro, NC (US); Kenneth L. Ringeman, Kernersville, NC (US)

Correspondence Address: WITHROW & TERRANOVA, P.L.L.C., 100 REGENCY FOREST DRIVE, SUITE 160, CARY, NC, 27518, US

(73) Assignee: GILBARCO INC., Greensboro, NC (US)

(21) Appl. No.: 11/531,743

(22) Filed: Sep. 14, 2006

(51) Int. Cl. G06Q 20/00

(52) U.S. Cl. 705/21

(57) ABSTRACT

A failsafe, redundant storage system for storing additional copies of off-line transactional or payment information generated by service station forecourt devices. The forecourt devices accept customer payment information for carrying out transactions. The payment information is communicated to a payment server for processing. The forecourt devices may be configured to allow customers to initiate and carry out payment transactions even if payment processing is unavailable or off-line. In this instance, the off-line payment information is stored locally at the forecourt device and communicated to the payment server for processing once back online. The forecourt devices communicate with each other in a peer-to-peer fashion to provide another backup of off-line payment information stored locally at the forecourt device. In this manner, a failure of a forecourt device's local memory will allow another forecourt device to recreate the off-line payment data stored for payment processing once the payment server is back online.

### FIELD OF THE INVENTION

The present invention relates to a failsafe peer-to-peer redundant storage system for transactional data generated by off-line retail terminals, and in particular fuel dispenser forecourt devices, in a service station environment.

### BACKGROUND OF THE INVENTION

Fuel service stations now commonly provide fuel dispensers that are equipped with card readers for acceptance of credit and/or debit cards for payment. This is commonly referred to as “pay-at-the-pump”. A fuel dispenser in a service station environment accepts a customer's credit or debit card for payment of fuel via the card reader. The card reader is adapted to read the customers account information from their payment card. After this payment information is received via the card reader, it is communicated to a control system, typically within the fuel dispenser. The fuel dispenser then communicates the payment information, typically over a communication network, to a site controller. The site controller then communicates this payment information off-site to a host processing system, where it is processed and determined if the payment data is approved. If the payment data is approved, meaning the customer has authorization to charge their transaction to their payment card account, the host processing system will send a communication message back to the site controller. In turn, the site controller will communicate this authorization to the individual fuel dispenser. Thereafter, fuel dispensing is authorized and will be charged to the customer's payment account. Other forms of payment readers can also be provided on fuel dispensers, such as bar code readers, transponders for communicating with RFIDs, Smartcard readers, and the like.

As service station environments have become more complex, fuel dispensers have developed into customer activated kiosks that are also capable of acting as stand-alone point-of-sale (POS) devices. The fuel dispensers can enable the customer to not only order fuel, but other services as well, such as food, information, and car washes, for example. Because of this expanded functionality of the fuel dispenser, it is important to provide uninterrupted service for customers. Thus, for example, if communications between the site controller and the host processing system were unavailable for processing of payment, it still may be desirable to allow the customers to request transactions without interruption. The payment information would have to be processed off-line in this instance. Off-line transaction processing can occur as a result of a communication problem with the site controller, or as a result of a communication problem between the site controller and the host processing system.

If payment information is processed off-line, payment transactions must be stored for later communication and reconciliation with the host processing system so that these transactions are not lost. Otherwise, the retailer would be unable to receive payment for stored transactions when communication links are later restored, thus resulting in lost revenue. For off-line payment processing, the off-line payment transactions are typically stored locally in the fuel dispenser when it is acting as a stand-alone (POS) device. The off-line payment transactions are processed at a later time when the site controller and/or host processing are back online and operational.

However, even though a fuel dispenser or other forecourt device may be capable of storing payment transactions locally, the fuel dispenser or other forecourt device could fail as well. In this event, the stored off-line transactions would be lost forever, and payment would be lost to the retailer since no reconciliation could occur once operations are back online. Some service stations do employ a printer or electronic journal to capture payment processing as a backup system. However, these backup systems typically require manual intervention, may not be provided, may additionally not be functional and/or may not be provided in the fuel dispensers themselves. Thus, any of these problems would still result in lost payment transactions or delays in processing credit card transactions when a fuel dispenser fails.

### SUMMARY OF THE INVENTION

The present invention is a failsafe, redundant storage system for storing additional copies of off-line transactional or payment information generated by retail terminals. In particular, the retail terminals may be fuel dispensers or other service station forecourt devices that include retail terminals for handling retail transactions initiated by customers. The forecourt devices may continue to allow customers to initiate and carry out transactions using payment accounts even if payment processing is unavailable or off-line. In this manner, the forecourt devices are not rendered inoperable for handling customer transactions if payment processing is not available at a convenience to customers. The off-line payment information is stored locally on the forecourt device and communicated for processing once payment processing is back online.

The present invention additionally provides the ability for the forecourt devices to communicate with each other in a peer-to-peer fashion to provide a backup of off-line payment information stored locally at the forecourt devices. In this manner, the service station operator has additional assurance that in the event that a forecourt device's local memory or storage of off-line payment information becomes corrupted or unavailable when payment processing is back online, another forecourt device will have the ability to restore the off-line payment data. Thus, critical payment information for the service station to receive credit for customer transactions and receipt of goods and/or services is backed up as a failsafe measure. Service station operators are more likely to allow off-line transactions if such a failsafe method is provided.

Forecourt devices are located in a service station environment. Forecourt devices may include fuel dispensers, a car wash, quick-service restaurant (QSR), and a convenience store. The forecourt devices include the ability of a customer to pay for requested goods and/or service via a payment card or other payment medium. The forecourt devices are communicatively coupled to a local area network (LAN). In this manner, when a payment transaction is requested at a forecourt device, the control system of the forecourt devices sends the payment request and related payment information from the payment medium presented by the customer over the LAN to a payment server for processing and authorization. The payment information may be communicated to a host processing system via an off-site communication link for processing and authorization.

In one embodiment of the present invention, a single data replication service coupled to the LAN is provided to receive and store off-line transactions stored by forecourt payment devices in local storage. The data replication service communicates with each of the forecourt devices in a peer-to-peer manner. The data replication service receives off-line payment information from a forecourt device, and back up storage of such payment information in the local memory of other forecourt devices. In this manner, because of the data replication, if a local storage device that stores an off-line transaction becomes unavailable, corrupted, or otherwise not usable, the transaction data is not lost, and can be obtained from a replicated data source. This is because the forecourt payment devices are capable of communicating with each other in a peer-to-peer manner, rather than just directly with the payment server.

In an alternative embodiment, each forecourt payment device maintains its own replication data service that is offered to all forecourt payment devices over the LAN. On start up, a voting mechanism is used to determine which forecourt payment devices hold the correct off-line transaction data in case one is replaced or corrupted, or holds stale data. Each replication data service is a process that is provided within the forecourt payment devices. Replication data stores for backup of off-line payment transactions for each replication data service is provided as part of the local memory for each forecourt device. Each forecourt device is virtually connected to each replication data service in a peer-to-peer connection via virtual links over the LAN. When a forecourt payment device conducts an off-line transaction, not only is the transaction data stored in the local forecourt memory, but it is also provided to the replication data service, which then replicates the transaction data in other replication data stores. Thus, all replication data stores should contain all off-line transaction processing data, and be mirror images of each other unless one of the replication data stores encounters a failure. In this event, the voting scheme still operates properly to allow all replication data stores to provide the payment server with the off-line transaction data for processing once the payment server becomes available.

In another embodiment, only a primary data server and a secondary data server are provided in lieu of a replication data service being provided for each forecourt payment device. Each data server contains its own primary data and secondary data. The primary data server is associated with one of the forecourt payment devices. The secondary data server is associated with a second forecourt payment device. In this manner, only two replication data services exist for the storage of off-line transaction data in a replication manner for later processing by the payment server in the event that the forecourt payment devices fail. The primary data server and secondary data server are provided as part of a forecourt payment device's local memory. Each of the forecourt payment devices is coupled to the primary data server and the secondary data server via communications over the LAN using peer-to-peer virtual communication links. In this manner, every time one of the forecourt payment devices processes an off-line payment transaction in the event that the payment server is not available, the transaction data is communicated to each of the data servers so that the transaction data can be additionally stored in the primary data server and the secondary data server for replication of storage.

Those skilled in the art will appreciate the scope of the present invention and realize additional aspects thereof after reading the following detailed description of the preferred embodiments in association with the accompanying drawing figures.

### BRIEF DESCRIPTION OF THE DRAWINGS

The accompanying drawing figures incorporated in and forming a part of this specification illustrate several aspects of the invention, and together with the description serve to explain the principles of the invention.

FIG. 1 illustrates a typical service station environment and communication architecture thereof;

FIG. 2 illustrates an exemplary fuel dispenser;

FIG. 3 illustrates a fuel dispenser/forecourt device communication architecture in accordance with the prior art;

FIG. 4 illustrates a fuel dispenser/forecourt device communication architecture in accordance with one embodiment of the present invention;

FIG. 5 illustrates a state machine for peer-to-peer data replication in accordance with one embodiment of the present invention;

FIG. 6 is a flow chart illustrating processing for the off-line state as provided in FIG. 5;

FIG. 7 illustrates processing for the online state as illustrated in FIG. 5;

FIG. 8 illustrates a second embodiment for peer-to-peer data replication;

FIG. 9 illustrates the processing for the off-line state for the data replication architecture illustrated in FIG. 8 using the state machine in FIG. 5;

FIG. 10 is a flow chart illustrating processing of the online state for the data replication embodiment in FIG. 8 using the state machine illustrated in FIG. 5;

FIG. 11 illustrates a third alternative data replication embodiment;

FIG. 12 is a flow chart illustrating processing for the off-line state for the data replication embodiment in FIG. 11; and

FIGS. 13A and 13B illustrate processing for an online state for the data replication embodiment illustrated in FIG. 11.

### DETAILED DESCRIPTION OF THE PREFERRED EMBODIMENTS

The embodiments set forth below represent the necessary information to enable those skilled in the art to practice the invention and illustrate the best mode of practicing the invention. Upon reading the following description in light of the accompanying drawing figures, those skilled in the art will understand the concepts of the invention and will recognize applications of these concepts not particularly addressed herein. It should be understood that these concepts and applications fall within the scope of the disclosure and the accompanying claims.

The present invention is a failsafe, redundant storage system for storing additional copies of off-line transactional or payment information generated by retail terminals. In particular, the retail terminals may be fuel dispensers or other service station forecourt devices that include retail terminals for handling retail transactions initiated by customers. The forecourt devices may continue to allow customers to initiate and carry out transactions using payment accounts even if payment processing is unavailable or off-line. In this manner, the forecourt devices are not rendered inoperable for handling customer transactions if payment processing is not available as a convenience to customers. The off-line payment information is stored locally on the forecourt device and forwarded for processing once payment processing is back online.

The present invention additionally provides the ability for the forecourt devices to communicate with each other in a peer-to-peer fashion to provide a backup of off-line payment information stored locally at the forecourt devices. In this manner, the service station operator has additional assurance that in the event a forecourt device's local memory or storage of off-line payment information becomes corrupted or unavailable when payment processing is back online, another and/or replacement forecourt device will have the ability to recreate the off-line payment data. Thus, critical payment information for the service station to receive credit for customer transactions and receipt of goods and/or services is backed up as a failsafe measure. Service station operators are more likely to allow off-line transactions if such a failsafe method is provided.

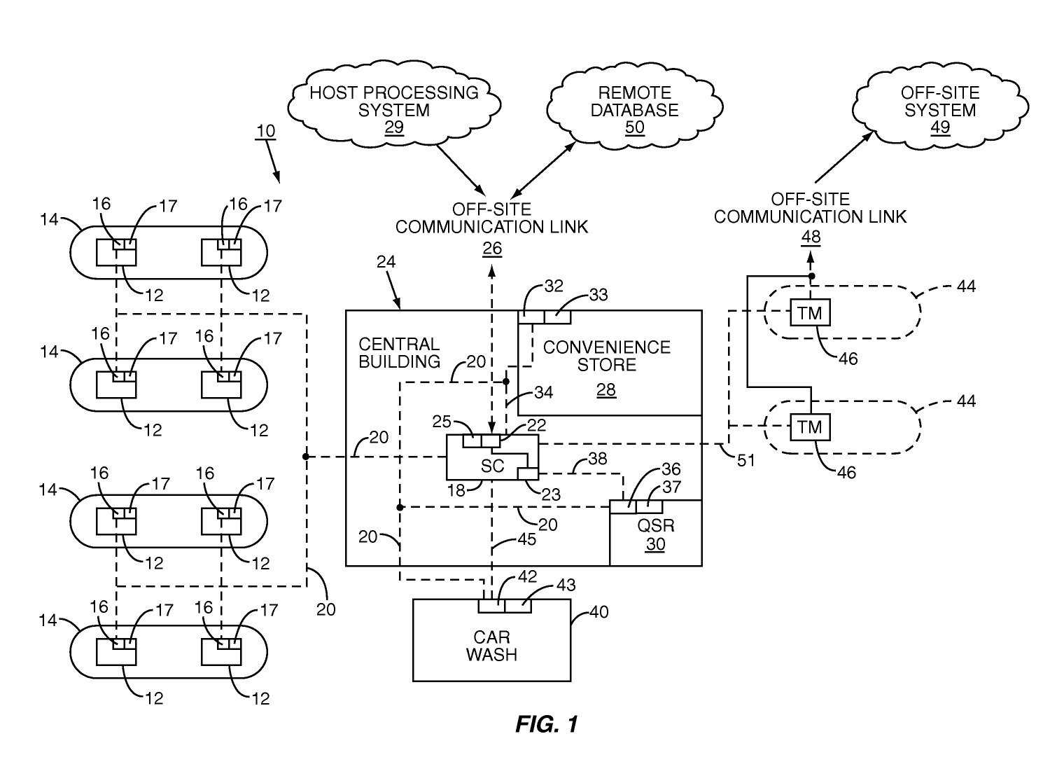

FIG. 1 illustrates a service station 10 according to one embodiment of the present invention. FIG. 1 illustrates the various forecourt devices and communication architectures that are present in a typical service station 10. One or more fuel dispensers 12 are provided on raised islands 14 in the service station 10 area for fueling of vehicles. The fuel dispensers 12 each contain a control system 16, which controls the operations of the fuel dispensers 12. A database or memory 17 may be provided within each fuel dispenser 12 that is communicatively coupled to the control system 16 for storage of transactions or other data, as required by the control system 16. Examples of fuel dispensers 12 may be the Gilbarco® Encore® and Eclipse® fuel dispensers manufactured by Gilbarco Inc., the assignee of the present invention.

The fuel dispensers 12 are known as forecourt devices, meaning that they are provided in the forecourt area of the service station 10. Other forecourt devices can be provided in the service station 10, such as a car wash, quick-service restaurant, etc., as described below. The fuel dispensers 12 are typically controlled by a site controller 18, which is communicatively coupled to the fuel dispensers 12 via a communication loop or Local Area Network (LAN) 20. In this manner, when a transaction is requested at a fuel dispenser 12, the control system 16 sends a request over the communication loop or LAN 20 to the site controller 18. The site controller 18 then determines if the transaction is authorized. If so, the site controller 18 sends an authorization message over the communication loop or LAN 20 to the fuel dispenser 12 to authorize fuel dispensing. Thereafter, fuel dispensing can begin.

The site controller 18 can be configured to allow a variety of different configurations for authorizing fuel dispensers 12. The site controller 18 may be configured to require customers to “pre-pay” for fuel prior to activating the fuel dispenser 12. In this manner, the customer must either present a payment card at the fuel dispenser 12, or the operator of the site controller 18 must manually authorize the fuel dispenser 12, typically after a deposit is left.

A control system 22 is typically housed or provided inside a central building 24. The control system 22 may also comprise a payment server 23 and a printer or electronic journal 25. The payment server 23 is used to authorize payment when payment cards are presented for payment by customers, either at the fuel dispensers 12 or to the operator of the site controller 18. Typical payment methods include credit and debit cards, but can also include other forms such as bar codes, RFID transmissions, SmartCards, etc. When the control system 22 processes the customer's payment, the control system 22 may print all transactions to the printer or electronic journal 25 as a back-up or archival copy of the transactions.

After the site controller 18 and/or its control system 22 receives the customer's payment information, either from the fuel dispenser 12 or at the site controller 18 directly, the payment information is typically communicated to a host processing system 29 via an off-site communication link 26. The host processing system 29 then determines if the customer's payment information is authorized. The authorization status is then communicated back to the site controller 18 via the off-site communication link 26 and processed by the payment server 23. If the payment card has been authorized, the payment server 23 will indicate to the control system 22 or the site controller 18 that the transaction is authorized. In the example of fuel dispensing, a signal is sent over the communication loop or LAN 20 by the site controller 18 to the fuel dispenser 12 to authorize fuel dispensing.

In the event the customer presents a payment card that does not require off-site authorization using the host processing system 29, but rather the payment server 23 or the site controller 18 can itself authorize such payment card, the site controller 18 will determine if such payment card is authorized without communicating to the host processing system 29. The payment server 23 may contain a local database of payment cards or other accounts that customers may use for payment that only requires on-site authorization.

Other forecourt devices or operations may also be provided in the service station 10, and particularly within the central building 24. For example, the central building 24 may also contain a convenience store 28 and/or a quick service restaurant (QSR) 30. The convenience store 28 and QSR 30 may be cooperatively operative with the site controller 18 for processing of transactions. The convenience store 28 typically contains a control system or POS 32, which is communicatively coupled to a database or memory 33. The control system 32 may also be communicatively coupled to the site controller 18 via a communication link 34. In this manner, orders placed at the fuel dispenser 12 and/or site controller 18 for items that are available via the convenience store 28 can be processed via communication between the site controller 18 and the control system 32. Operators may also directly control the control system 32 for the convenience store 28 for processing of orders or other processing.

Likewise, in a similar manner, the QSR 30 may contain a control system or POS system 36 that is communicatively coupled to the site controller 18 via communication link 38. In this manner, food orders placed at the fuel dispensers 12 or at the site controller 18 can be communicated to the control system 36 for handling and/or processing. The control system 36 may also allow an operator to directly interface with the QSR 30 for processing of orders or handling of transactions. The control system 36 is communicatively coupled to a database 37 associated with the QSR 30 for storage of transactions.

In lieu of the convenience store 28 and the QSR 30 having their own communication links 34, 38 directly coupled to the site controller 18, the convenience store 28 and QSR 30 may be communicatively coupled to the LAN 20, in the same manner as the fuel dispensers 12. In this manner, their respective control systems 32, 36 are peer forecourt devices to the fuel dispensers 12. The site controller 18 would communicate with the fuel dispensers 12, the convenience store 28, and the QSR 30 on the same network. Even if the convenience store 28 and the QSR 30 are not coupled to the LAN 20, they can communicate as peer devices with the fuel dispensers 12 via the site controller 18.

Some service stations 10 may also contain a car wash 40 that is located outside the central building 24, but proximate thereto. In this manner, customers can request a car wash. The car wash 40 contains a control system or POS system 42 to allow the customer to request a car wash, and for handling of payment and other control. The control system 42 is communicatively coupled to a database or memory 43 for storage of the transactions conducted by the car wash 40 in the database or memory 43. The car wash 40 may be directly coupled to the site controller 18 via its own communication link 45. In this manner, customers desiring to pay for a car wash can order the car wash at the fuel dispenser 12 and/or directly at the site controller 18. In response thereto, the site controller 18 sends the communication message over the communication link 45 to the control system 42. Typically, the control system 42 sends a car wash code back to the site controller 18 to present to the customer. The car wash code can then be used to authorize a car wash according to the type of car wash paid for by the customer. Just like the convenience store 28 and the QSR 30, the control system 42 may also be communicatively coupled to the LAN 20 instead of having its own dedicated communication line coupled to the site controller 18 via communication link 45. In either scenario, the car wash 40 may communicate with the other forecourt devices in a peer-to-peer fashion.

The service station 10 also typically contains one or more fuel storage tanks 44 that contain fuel to be delivered and dispensed by the fuel dispensers 12. The fuel storage tanks 44 typically contain a dedicated tank monitor 46 that provides inventory reconciliation, tank gauging, and other monitoring control functions, as is well known. An example of a tank monitor 46 is the TLS-350 tank monitor manufactured by the Veeder-Root Company. Tank monitors 46 may be communicatively coupled to an off-site communication link 48 for reporting of data and other monitoring functions, as well as for receipt of control information to and from an off-site system 49. The fuel from the fuel storage tanks 44 is transported in underground fuel piping (not shown) to reach the fuel dispensers 12 for eventual delivery to a vehicle. The tank monitors 46 may also be communicatively coupled to the site controller 18 via a communication link 51, so that the tank monitors 46 can reconcile their inventory levels with the information about fuel dispensed from the site controller 18. The site controller 18 receives fuel dispensed meter data from the individual fuel dispensers 12 and their fuel meters (not shown).

Further, the off-site communication link 26 may be coupled to a remote database 50 for remote storage of transactions that would normally be stored in the printer or electronic journal 25 for site controller 18. This provides the ability to provide an off-site backup storage system for transaction data.

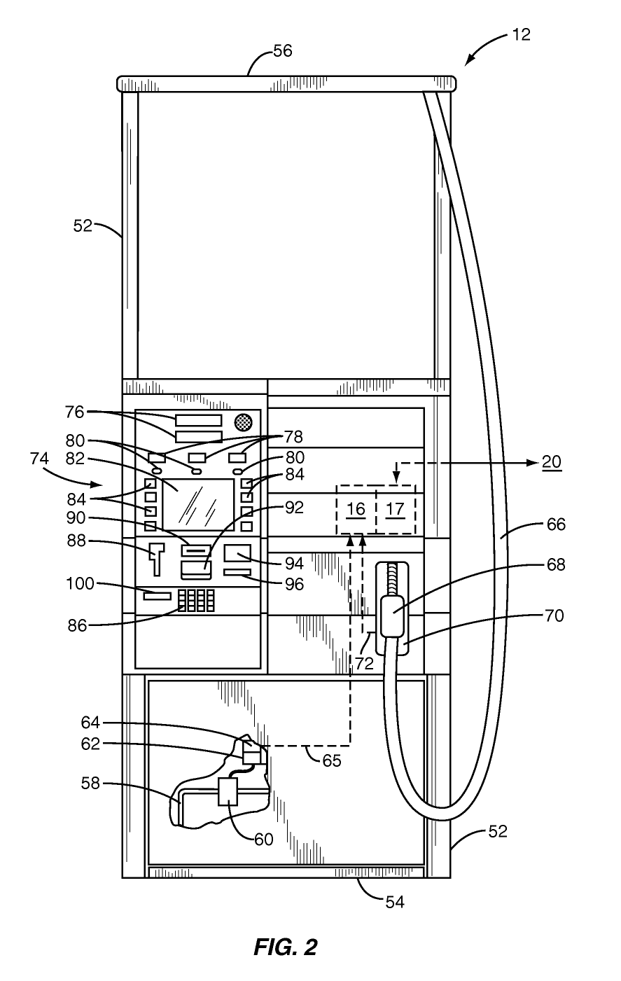

FIG. 2 illustrates an exemplary fuel dispenser 12. The fuel dispenser 12 is typically comprised of one or more sides 52 that are attached to a base 54 and a canopy 56. Fuel delivered from the fuel storage tanks 44 is delivered to the fuel dispenser 12 via fuel dispenser piping 58. The fuel travels through the fuel dispenser piping 58 and past a fuel flow meter 60. The fuel flow meter 60 communicates a signal indicative or volume and/or flow rate of the fuel to a pulse wheel 62. The pulse wheel 62 allows a pulse generator 64 to generate pulse signals indicative of the fuel flow and/or volume. These pulse signals are communicated over signal link 65 to the control system 16. In this manner, the control system 16 can track the amount of fuel that is dispensed to a customer. After the fuel travels past the fuel flow meter 60, it is delivered to a hose 66 and through a nozzle 68 to the customer's vehicle (not shown). The nozzle 68 is placed inside a nozzle boot 70 provided on the fuel dispenser 12 when not in use. When the customer desires to dispense fuel at the fuel dispenser 12, the customer removes the nozzle 68 from the nozzle boot 70 to initiate this request. The nozzle boot 70 typically contains a sensor or other device that communicates a signal to the control system 16 over a communication link 72 indicating a request for a new fuel dispensing transaction.

The fuel dispenser 12 typically contains a user interface 74, especially for more modern fuel dispensers 12 that act as a kiosk and allow for payment of fuel at the fuel dispenser 12. The user interface 74 is comprised of a transaction totals display 76 that provides information to the customer about the amount of fuel dispensed in terms of volume, and the price to be charged. The control system 16 converts the pulse signals from the fuel flow meter 60 via signal link 65 into a total amount of gallons and price to be charged to the customer, and communicates such to the transaction totals display 76 for display to the customer. The fuel dispenser 12 illustrated in FIG. 2 is a multi-product dispenser (MPD), meaning that it can dispense more than one grade or type of fuel. Because of this, each grade of fuel may have different prices. The price-per-unit (PPU) of each type of fuel is typically displayed on a PPU display 78. Octane selection buttons 80 are provided so that the customer can select which grade of fuel they desire to be dispensed.

A main instruction display or screen 82 is provided to present the customer with instructions during the fueling transaction and/or advertising or other content information. Some of these instructions require the customer to respond via input. The customer can respond to prompts via soft keys 84. The main instruction display 82 displays prompts wherein a response choice is aligned with one or more of the soft keys 84. Thus, the customer can select the correct soft key 84 to correspond to their input or decision. The customer may also provide input for response to prompts via a keypad 86.

The fuel dispenser 12 may also contain a card reader 88 that is used to receive a customer's card for payment of fuel at the fuel dispenser 12. Other forms of input devices can be provided for payment processing, including a bill acceptor 90, a barcode reader 92, an RFID or RF transponder reader 94, and a biometric reader 96. A physical receipt may be given to the customer in response to a transaction via a receipt printer 100.

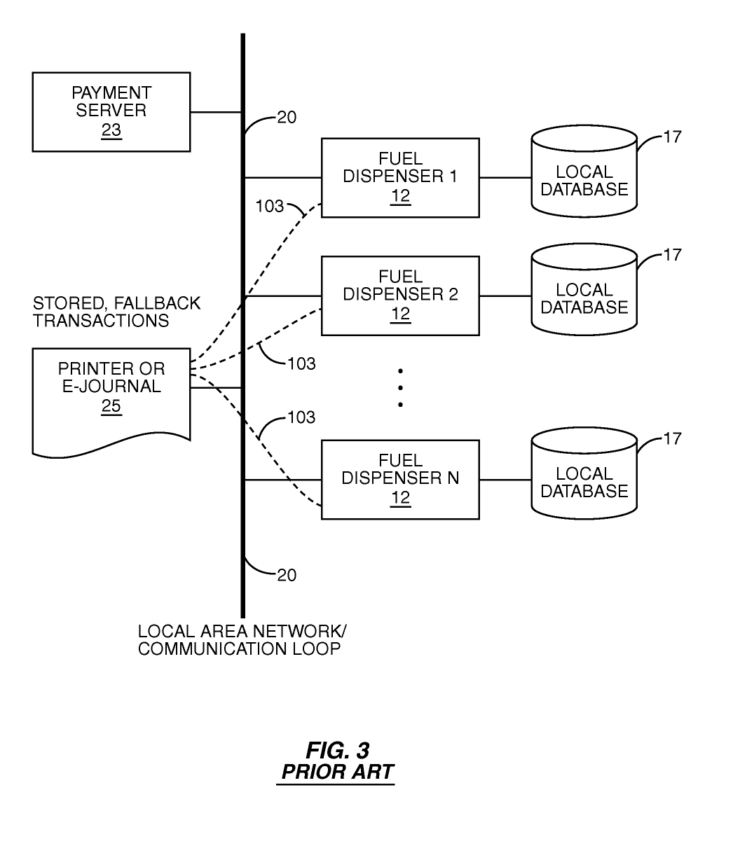

FIG. 3 illustrates a communication architecture in accordance with the prior art. As illustrated in FIG. 3, each of the fuel dispensers 12 are communicatively coupled to the communication loop or LAN 20, as previously described. This is the communication architecture in which the fuel dispensers 12 can communicate with the payment server 23 and/or the printer or electronic journal 25 for storage of transactions. The fuel dispensers 12 receive payment or other transaction information and communicate such to the payment server 23 and the printer or electronic journal 25 via the communication loop or LAN 20 when online. Virtual communication links 103 are established between the fuel dispensers 12 and the printer or electronic journal 25 over the LAN 20. In this manner, the payment server 23 handles processing of the payment presented at the fuel dispenser 12. A copy of the transaction is printed out on the printer 25 or stored in the electronic journal 25. In this manner, if any problems arise in the payment server 23, the transactions are recorded in the printer or electronic journal 25 for use to recreate the transaction for processing. In this manner, the service station 10 is protected from any lost transactions so that revenue is not lost.

If the payment server 23 became not available or off-line, the fuel dispenser 12 would not be able to communicate transaction data for processing by the payment server 23. Thus, if the fuel dispenser 12 is configured to continue to operate off-line and continue accepting payment transactions, the fuel dispenser 12 must store the transaction data off-line via the database or memory 17. If so configured, the fuel dispenser 12 can continue to process customer transactions and payments in an off-line mode by storage of the transaction data in the local database or memory 17. Some service station 10 operators may desire to take the risk of processing transaction data off-line to allow customers to continue dispensing fuel as opposed to causing the fuel dispenser 12 to be inoperable or not available. However, if the local database or memory 17 that stores transactions for the fuel dispensers 12 processing off-line transactions and/or the printer or electronic journal 25 were to become corrupt or otherwise not available, these stored transactions would be lost forever. This is because the transaction data would not have been sent to the payment server 23 for processing. Thus, the system illustrated in FIG. 3 causes a potential for lost transactions, and thus lost revenue for the service station 10 operator in the event that the fuel dispenser 12 is configured to allow off-line processing of transaction data when the communication loop or LAN 20 is unavailable.

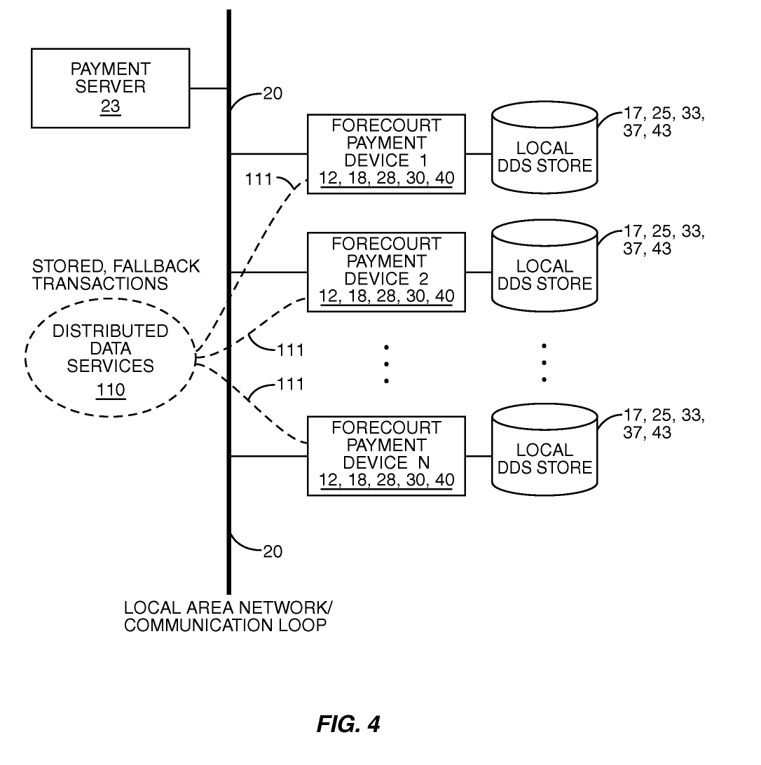

FIG. 4 illustrates a first embodiment of the present invention that provides for data replication of off-line transactions stored by forecourt payment devices in local storage. In this manner, because of the data replication, if a local storage device that stores an off-line transaction becomes unavailable, corrupted, or otherwise not usable, the transaction data is not lost, and can be obtained from a replicated data source. This is because the forecourt payment devices are capable of communicating with each other in a peer-to-peer manner, rather than just directly with the payment server 23.

As illustrated in FIG. 4, one or more forecourt payment devices 12, 18, 28, 30, 40 are provided. The present invention not only allows data replication or handling of off-line transactions by fuel dispensers 12, but also other forecourt devices, including the site controller 18, the convenience store 28, the QSR 30, and the car wash 40. Each of the forecourt payment devices 12, 18, 28, 30, 40, contain their own dedicated local distributed data server (DDS) store 17, 25, 33, 37, 43 for storage of transactions, including off-line transaction processing. The forecourt payment devices 12, 18, 28, 30, 40 communicate with each other in a peer-to-peer fashion via virtual communication links 111 over the LAN 20.

The virtual communication links 111 allow the forecourt payment devices 12, 18, 28, 30, 40 to communicate transaction data to a distributed data service (DDS) 110 that operates as middleware. The DDS 110 provides non-volatile storage across the group of peer forecourt payment devices 12, 18, 28, 30, 40. The DDS 110 uses the local DDS store 17, 25, 33, 37, 43 in order to manage replication of data services. In this manner, when each forecourt payment device 12, 18, 28, 30, 40 stores off-line transaction data in local DDS store 17, 25, 33, 37, 43, it also communicates this transaction data to the DDS 110 middleware via virtual communication link 111. In turn, the DDS 110 replicates this data in the other local DDS store 17, 25, 33, 37, 43 for the other forecourt payment devices 12, 18, 28, 30, 40. Thus, all of the off-line transaction data for the forecourt payment devices 12, 18, 28, 30, 40 is replicated in each of the local DDS store 17, 25, 33, 37, 43 for the forecourt payment devices 12, 18, 28, 30, 40.

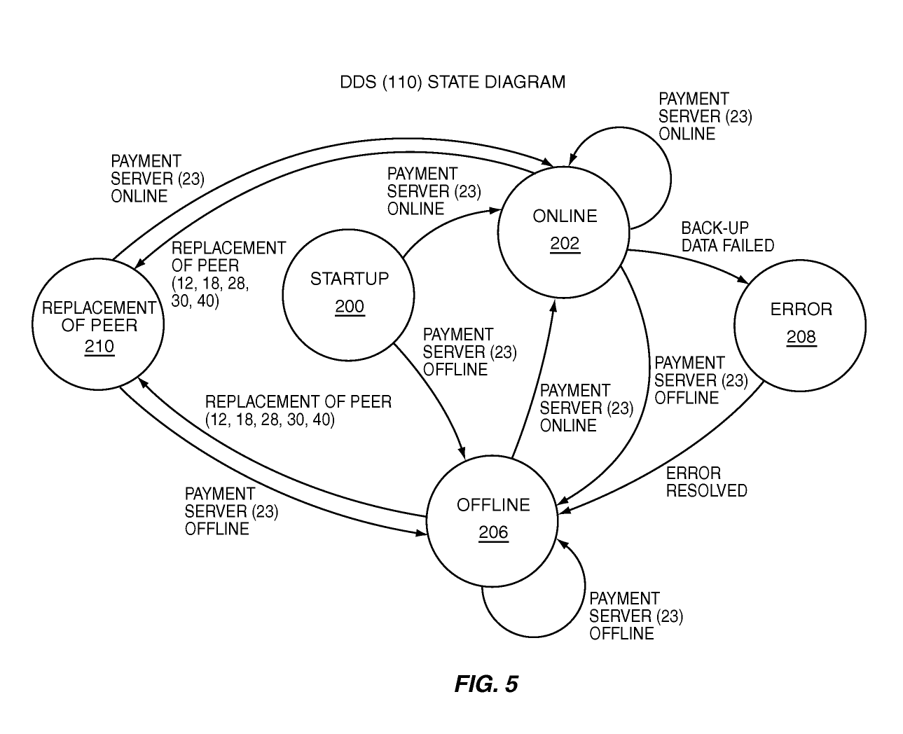

FIG. 5 illustrates a control process state diagram that may be executed by any of the forecourt payment devices 12, 18, 28, 30, 40, or the site controller 18 acting as a control device, to use the DDS 110 for replication of transaction data according to one embodiment of the present invention. The forecourt payment devices and/or site controller 12, 18, 28, 30, 40 execute a control process in accordance with a state machine for handling of replication data at the startup of such devices 12, 18, 28, 30, 40 and/or their control processes, and when the payment server 23 is both online and off-line. Further, the control process allows for the replacement of peer forecourt devices 12, 18, 28, 30, 40.

As illustrated in FIG. 5, when the payment server 23 is online, a control process 99 executing on one of the forecourt payment devices and/or site controller 12, 18, 28, 30, 40 in the online state 202. The control process 99 calls upon and queries the DDS 110 for performing distributed data services for storing off-line transactions when the payment server 23 is off-line. In this manner, the off-line transactions are stored for processing by the payment server 23 when back online. The control process 99 determines the status of the payment server 23 via communications on the LAN 20. The control process 99 continues to remain in the online state 202 as long as the payment server 23 remains online. If the payment server 23 goes off-line, the control process 99 changes states from the online state 202 to an off-line state 206. In this off-line state 206, the payment server 23 is off-line, and the control process 99 stores transaction data using the DDS 110 where the stored data is replicated to local DDS 110 stores in each forecourt payment device 12, 18, 28, 30, 40. The DDS 110 manages the storage and replication of data in a peer-to-peer fashion as illustrated in the architecture in FIG. 4.

During normal start up, the control process 99 enters a start up state 200. From there, the state machine transitions to either the online state 202 or off-line state 206, depending on whether the payment server 23 is online or off-line, respectively. If a peer forecourt payment device 12, 18, 28, 30, 40 is determined to be out of synchronization with the DDS 110 due to hardware replacement or recovery from some other failure, the control process enters 99 into the replacement of peer state 210 to call upon the DDS 110 to flush and replace any data cached within the local DDS store 17, 25, 33, 37, 43 with the correct configuration and/or transaction data for that peer using replication data from other local DDS store 17, 25, 33, 37, 43. A service technician only has to ensure that the replacement forecourt payment device 12, 18, 28, 30, 40 has a logical address in the LAN 20 that is set up before the control process automatically recovers the configuration of stored transactions to that replacement forecourt payment device's local DDS store 17, 25, 33, 37, 43.

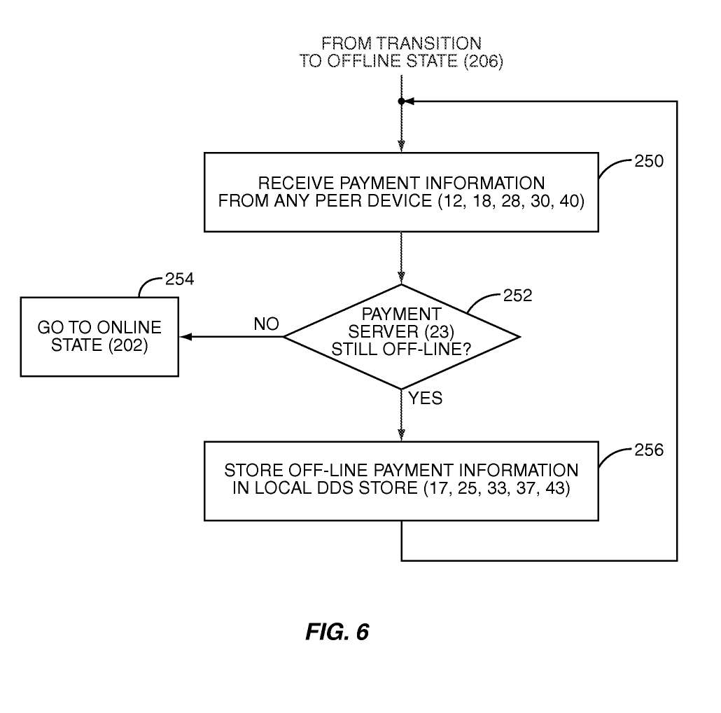

FIG. 6 is a flowchart illustration of the processing by the control process 99 when transitioning to the off-line state 206. Transition to the off-line state 206 is made when the payment server 23 becomes unavailable, and is thus off-line. The control process 99 manages payment information and state of the forecourt payment device 12, 18, 28, 30, 40 that has conducted an off-line transaction (step 250). The control process 99 determines if the payment server 23 is still off-line (decision 252). If not, the control process 99 transitions to the online state 202 (step 254), since the payment server 23 is now online. The payment information is then forwarded to and processed by the payment server 23, and is then deleted from the DDS 110. If the payment server 23 is still off-line at decision 252, the control process 99 calls upon the DDS 110 to store the off-line payment information in local DDS store 17, 25, 33, 37, 43 so that it is replicated among the other forecourt payment devices 12, 18, 28, 30, 40 in the event that the particular forecourt payment device 12, 18, 28, 30, 40 in which the payment information was generated becomes unavailable, or its local DDS store 17, 25, 33, 37, 43 becomes corrupted (step 256).

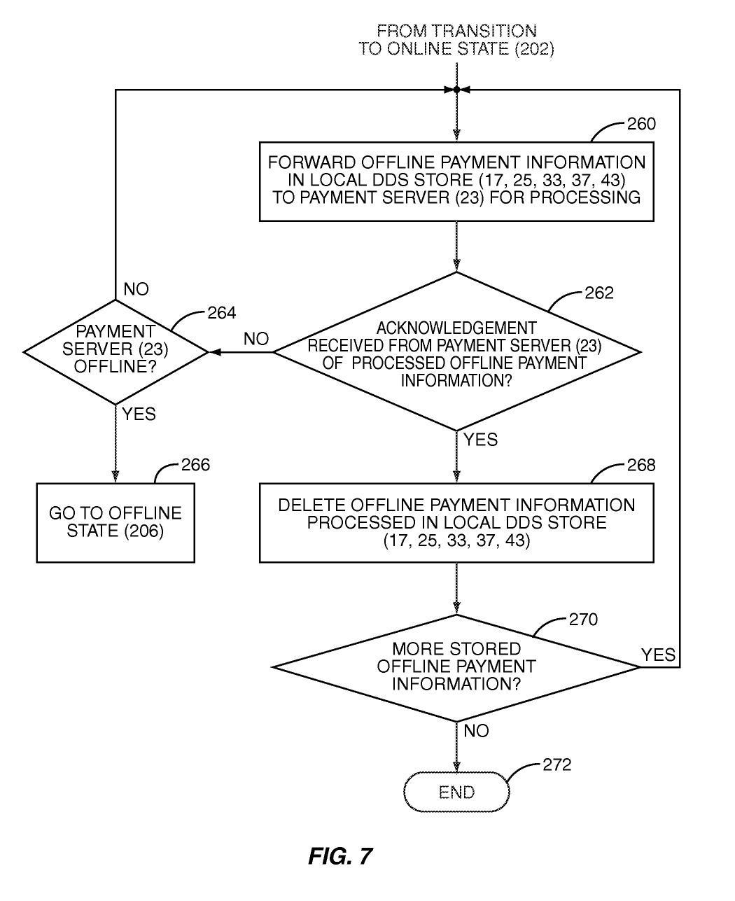

FIG. 7 is a flowchart illustration of the control processing that occurs when transitioning to the online state 202. A transition to the online state 202 is made when the payment server 23 is either available, or becomes available after having been in an off-line or unavailable state 206. The control process 99 calls upon the DDS 110 to retrieve off-line payment information that was previously stored and replicated in local DDS store 17, 25, 33, 37, 43. The control process 99 the forwards the payment information to the payment server 23 for processing, now that it is online (step 260). The control process 99 then waits to receive acknowledgement from the payment server 23 that the off-line payment information has been processed (decision 262). If it has been processed, the payment information is deleted from the DDS 110. If it has not been processed, the control process 99 determines if the payment server 23 has gone off-line (decision 264). If not, the process repeats until the payment server 23 acknowledges processing of the off-line payment information by going back to step 260.

If, in decision 264, the payment server 23 is off-line, the control process 99 transitions to the off-line state 206 (step 266) so that the control process 99 continues to call upon the DDS 110 to store off-line payment information until the payment server 23 is back online and available. If, in decision 262, the payment server 23 does acknowledge processing of the off-line payment information, the off-line payment information processed from the local DDS store 17, 25, 33, 37, 43 in which it was replicated is then deleted, since it has been properly processed (step 268). The control process 99 then determines if there is more stored off-line payment information that has not been processed (decision 270), and if so, the process repeats, going back to step 260, to retrieve payment information from the DDS 110 and then to forward this off-line payment information to the payment server 23. If all off-line payment information has been processed using the DDS 110 in decision 270, the process ends (step 272). In this manner, replicated data stored from off-line transactions is processed or cleared from the DDS 110 by the control process 99 through payment server 23 when the payment server 23 is available and in the online state 202, after having been replicated in forecourt payment devices 12, 18, 28, 30, 40.

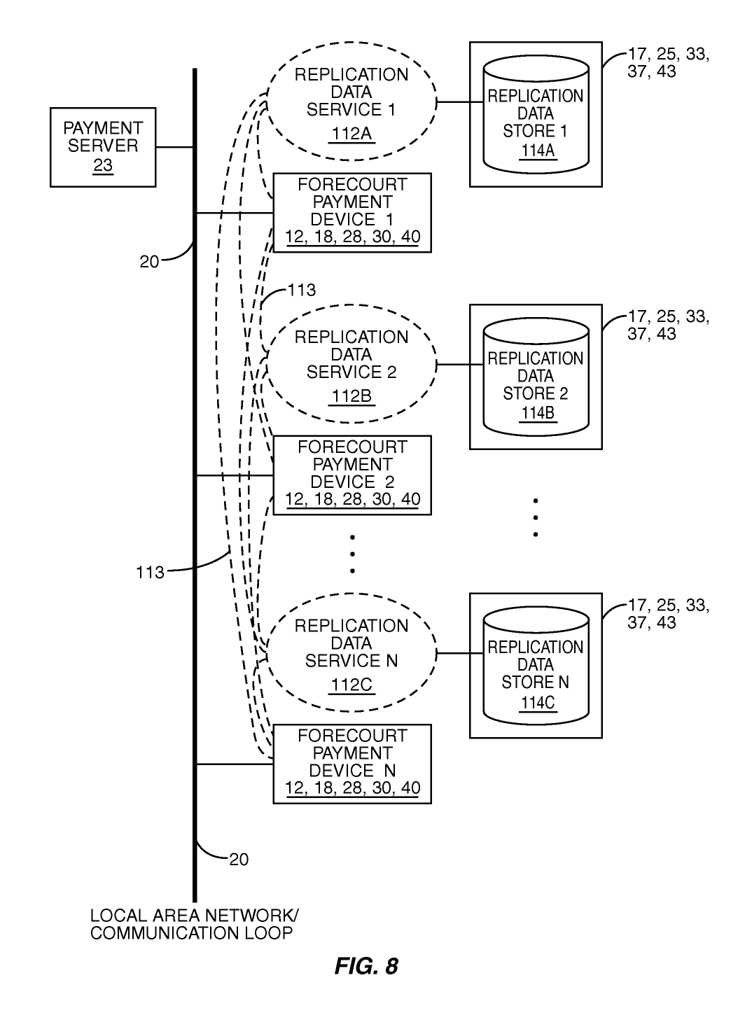

FIG. 8 illustrates an alternative embodiment of a replication data service for replication of transaction data stored by the forecourt payment devices 12, 18, 28, 30, 40 for off-line transactions when the payment server 23 is not available. Each forecourt payment device 12, 18, 28, 30, 40 maintains its own replication data service 112 that is offered to all forecourt payment devices 12, 18, 28, 30, 40 on the LAN 20. Each replication data service 112 is a process that is provided within the forecourt payment devices 12, 18, 28, 30, 40 and is called upon and controlled by a control process 111 executing in one of the forecourt payment devices 12, 18, 28, 30, 40 similar to the embodiment illustrated in FIG. 4. The replication data service 112 is contained within replication data store 114 that is part of the local DDS store 17, 25, 33, 37, 43. Each forecourt payment device 12, 18, 28, 30, 40 is virtually connected to each replication data service 112A, 112B, 112C in a peer-to-peer connection via virtual links 113 over the LAN 20.

On start up, a voting mechanism is used to determine which forecourt payment devices 12, 18, 28, 30, 40 hold correct off-line transaction data in the event one has been replaced or holds stale or corrupted data. In this embodiment it is also possible on startup of the forecourt payment device and/or its control process to have the forecourt payment device retrieve transaction data from a specific replication data service 112 managed by a specific forecourt device other than the one being replaced or reinitialized. When a forecourt payment device 12, 18, 28, 30, 40 conducts an off-line transaction, not only is the transaction data stored in the local data store 17, 25, 33, 37, 43, but the control process 111 also calls upon the replication data service 112, which then replicates the transaction data in other replication data stores 114. Thus, all replication data stores 114 should contain all off-line transaction processing data, and be mirror images of each other unless one of the replication data stores 114 encounters a failure. In this event, the voting scheme still operates properly to allow all replication data stores 114 to provide the payment server 23 with the off-line transaction data for processing once the payment server 23 becomes available.

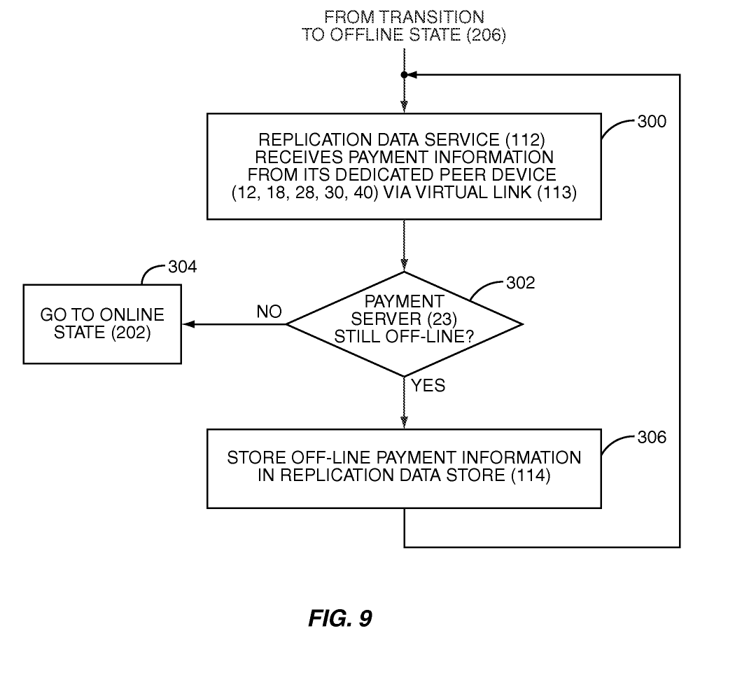

The state machine illustrated in FIG. 5 can also be used for the state machine for handling the replication data services 112 illustrated in FIG. 8. FIG. 9 is a flowchart illustration of the control process 111 that calls upon the replication data services 112 when transitioning to the off-line state 206. The replication data services 112 receive payment information from one of the forecourt payment devices 12, 18, 28, 30, 40 via the virtual links 113 in a peer-to-peer communication (step 300). The control process then determines if the payment server 23 is still off-line (decision 302). If not, then the control process 111 transitions to the online state 202 to process off-line transactions stored in the local data store and replication data stores 114 by calling upon the replication data service 112 (step 304). If the payment server 23 is still off-line in decision 302, the control process 111 calls upon the replication data services 112 to store the off-line payment information for one of the forecourt payment devices 12, 18, 28, 30, 40 in replication data store 114 (step 306) to save for later processing when the payment server 23 becomes available.

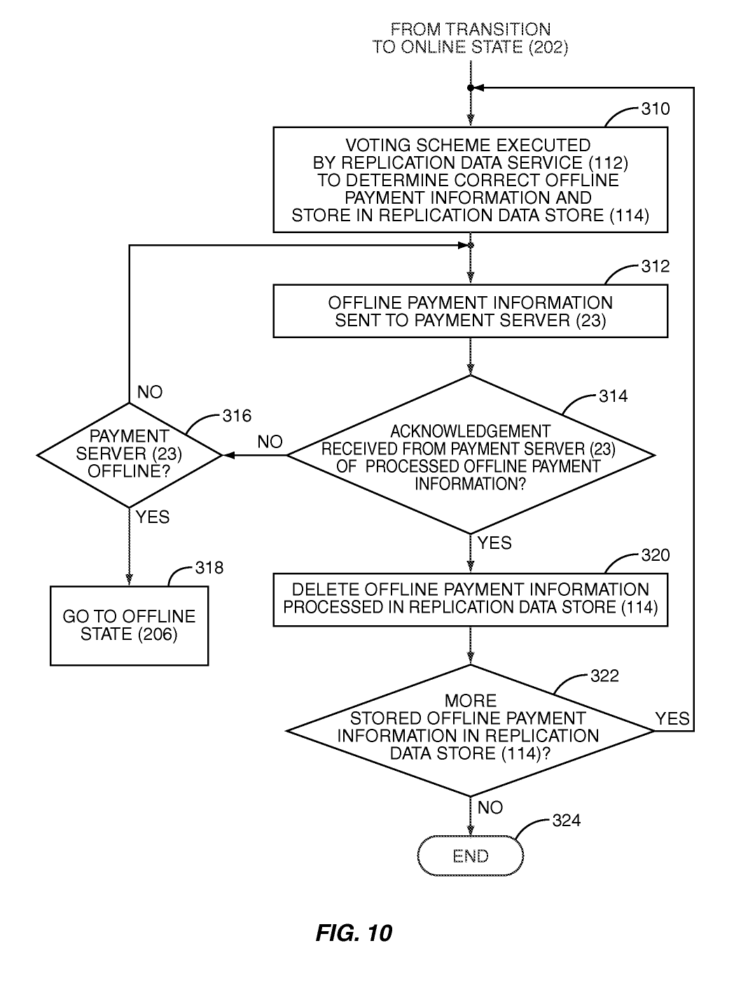

FIG. 10 is a flowchart illustration of the processing by the replication data service 112 when transitioning to the online state 202. The control process retrieves data from the local data store and sends the data to the payment server 23 for processing (step 312). The control process 111 then waits for acknowledgement from the payment server 23 that the off-line payment information has been received and processed (decision 314). If it has, the control process 111 deletes the data stored locally and calls upon the replication data services 112 to delete the off-line payment information held in the replication data store 114 (step 320) since the payment information has been properly processed by the payment server 23, and thus does not need to be stored as off-line payment transaction in replication data stores 114. If more stored off-line payment information exists that has not been processed (decision 322), the control process 111 repeats by going back to step 310, otherwise the process ends (step 324). If, back in decision 314, the payment server 23 was not able to acknowledge the processing of the off-line payment information, the control process 111 then determines that the payment server 23 has gone off-line (decision 316). If so, the control process 111 transitions to the off-line state 206 (step 318). If not, the control process 111 calls upon the replication data services 112 to attempt to send the off-line payment information to the payment server 23 for processing (step 312).

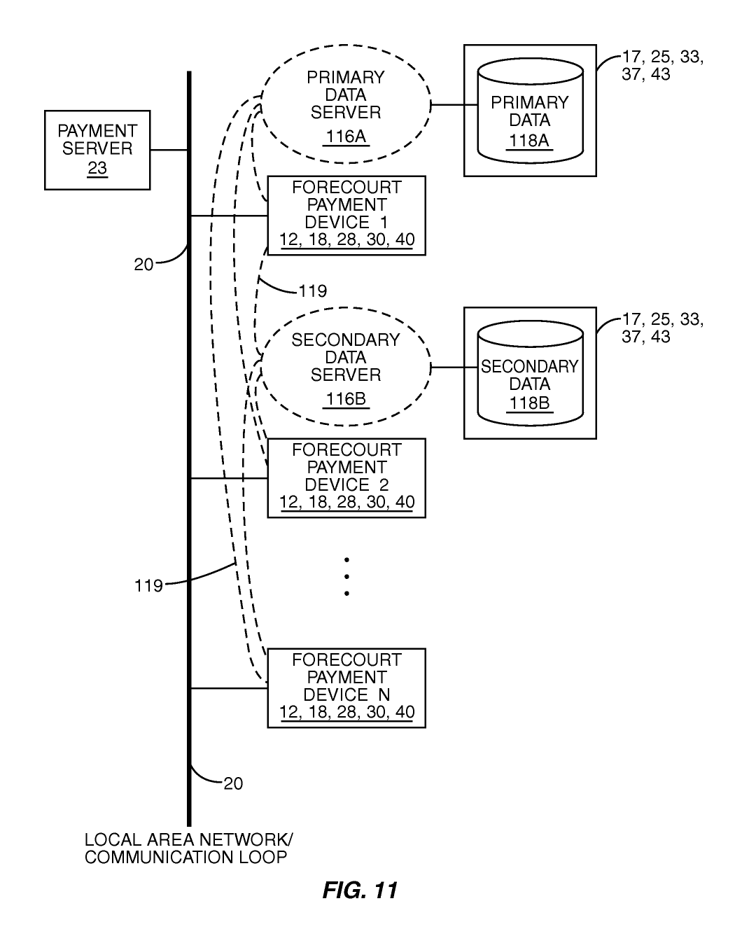

FIG. 11 illustrates yet another embodiment of a peer-to-peer off-line transaction storage system to process off-line transactions and provide replication of storage of data between forecourt payment devices 12, 18, 28, 30, 40. As illustrated in FIG. 11, only a primary data server 116A and a secondary data server 116B are provided in lieu of a payment server being provided for each forecourt payment devices 12, 18, 28, 30, 40. Each data server 116A, 116B contains its own primary data 118A and secondary data 118B. The primary data server 116A is associated with one of the forecourt payment devices 12, 18, 28, 30, 40. The secondary data server 116B is associated with a second forecourt payment device 12, 18, 28, 30, 40. In this manner, only two data replication services exist for the storage of off-line transaction data in a replication manner for later processing by the payment server 23 in the event that the forecourt payment devices 12, 18, 28, 30, 40 local DDS store 17, 25, 33, 37, 43 becomes corrupted or not available.

Typically, the primary data 118A and secondary data 118B are provided as part of the forecourt payment devices 12, 18, 28, 30, 40 local DDS store 17, 25, 33, 37, 43. Each of the forecourt payment devices 12, 18, 28, 30, 40 is coupled to the primary data server 116A and the secondary data server 116B via communications over the LAN 20 using peer-to-peer virtual communication links 119. One of the forecourt payment devices 12, 18, 28, 30, 40 executes a control process 113 that calls upon the primary data server 116A and secondary data server 116B to perform data replication and recall services. In this manner, every time one of the forecourt payment devices 12, 18, 28, 30, 40 processes an off-line payment transaction in the event that payment server 23 is not available, the transaction data is communicated by the control process 113 to each of the data servers 116A, 116B so that the transaction data can be additionally stored in the primary data 118A and the secondary data 118B for replication of storage.

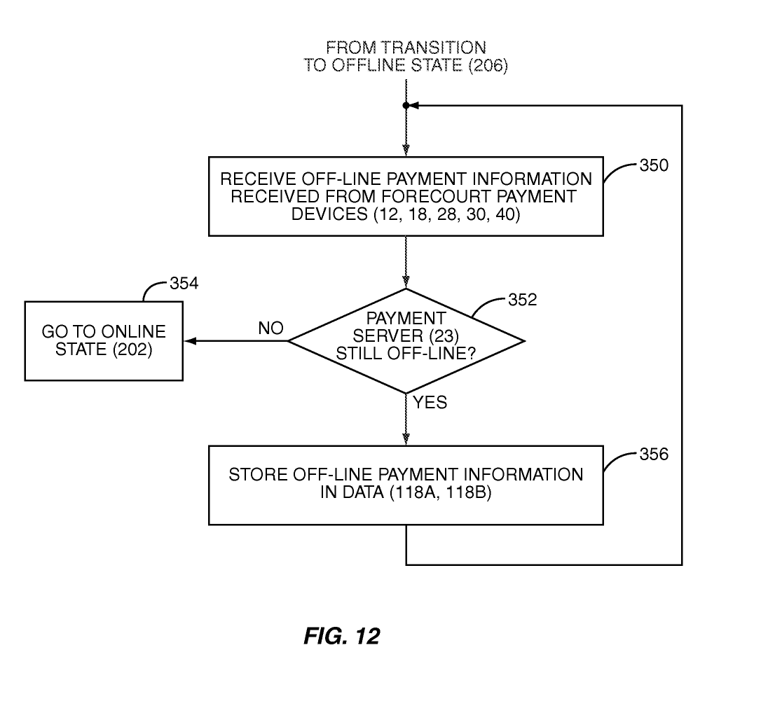

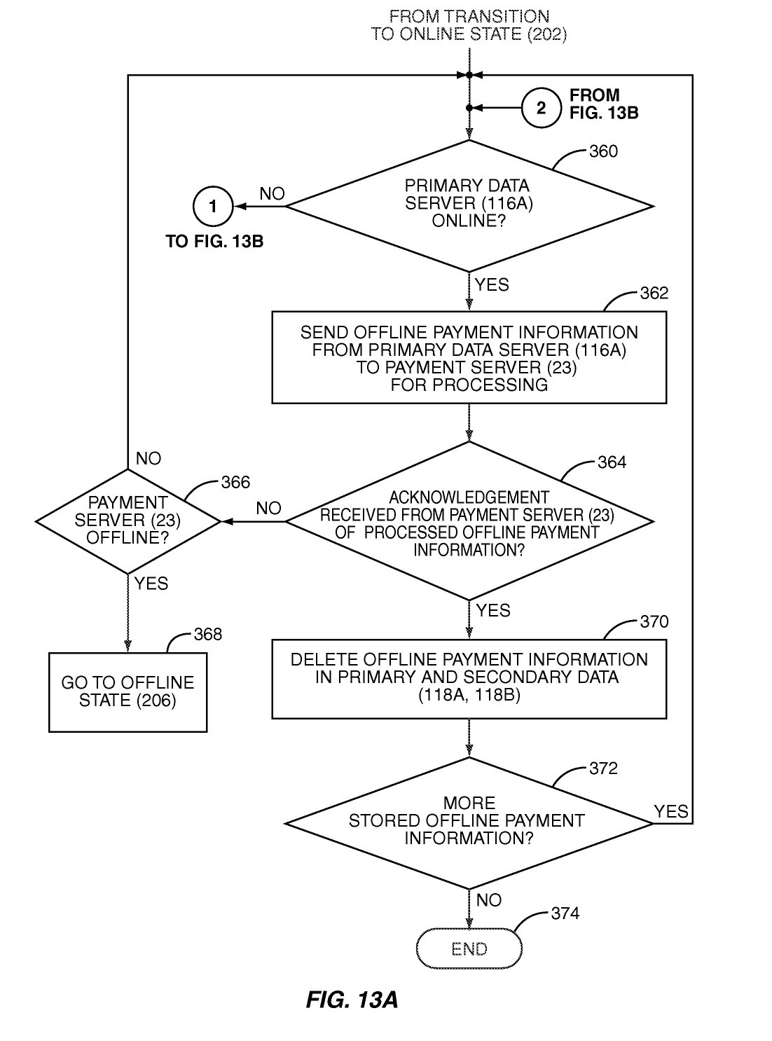

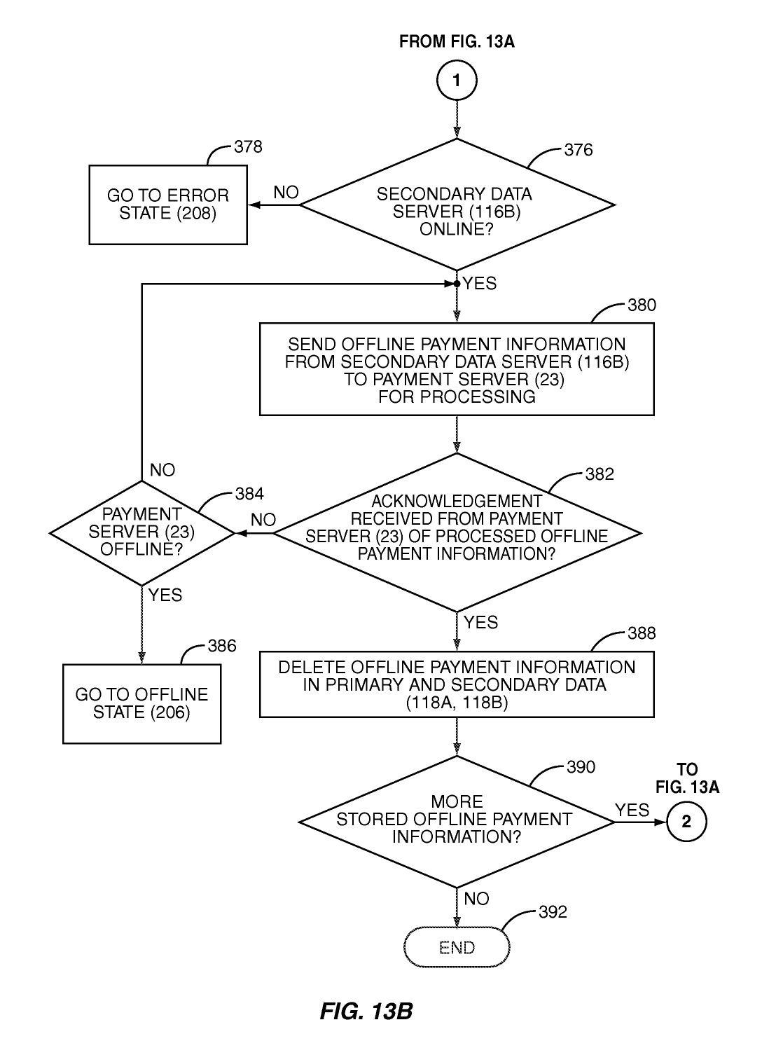

The flow charts illustrated in FIGS. 12 and 13 provide an illustration of the operation of the off-line and online processing of the control process 113 that calls upon the primary data server 116A and secondary data server 116B for replicating off-line transaction data and restoring and processing the off-line transaction data using the payment server 23 when the payment server 23 becomes available. The state machine illustrated as an example in FIG. 5 may be used to execute the control process 113.

As illustrated in FIG. 12, when the control process 113 transitions to the off-line state 206, the primary data server 116A and the secondary data server 116B receive off-line payment information from the forecourt payment devices 12, 18, 28, 30, 40 as previously discussed over the peer-to-peer virtual communication links 119 (step 350). After this information is received, the control process 113 determines if the payment server 23 is still off-line (decision 352). If yes, the off-line payment information is stored in the primary data 118A and secondary data 118B for later processing once the payment server 23 is back online (step 356), and the control process 113 repeats back to step 350. If the payment server 23 became online in decision 352, the control process 113 transitions to the online state 202 (step 354), since the payment server 23 is now available and the off-line payment information can be processed by the payment server 23 without need for storing it as off-line data.

FIGS. 13A and 13B illustrate the control process 113 when transitioning to the online state 202. If the control process 113 is online (decision 360), the control process 113 causes the off-line payment information to be retrieved from the primary data server 116A and forwarded to the payment server 23 for processing. If the primary data server is unavailable, the secondary data server 116B must be used to retrive off-line payment information that is forwarded to the payment server 23, as illustrated in FIG. 13B and described further below. The control process 113 determines if an acknowledgement has been received from the payment server 23 of the processed off-line payment information (decision 364). If yes, the control process 113 calls upon the primary server 116A and secondary server 116B to delete the off-line payment information from the primary data 118A and secondary data 118B stores, since the off-line payment information has been properly processed by the payment server 23 (step 370). The control process 113 then determines if there is more stored off-line payment information to be processed (decision 372). If so, the process repeats by returning back to step 360. If not, the process ends (step 374), since all off-line payment information has been processed by the payment server 23, and the payment server 23 is now in the online state 202.

If, in decision 364, an acknowledgement was not received from the payment server 23 of the processed off-line information, the control process 113 then determines that the payment server 23 is off-line (decision 366). If not, the process repeats to attempt to again call upon the primary data server 116A or secondary data server 116B to retrieve and forward the off-line payment information beginning at step 360. If the payment server 23 is off-line, the control process 113 goes to the off-line state 206 (step 368).

If, in decision 360, the primary data service 116A was not online, the secondary data server 116B will be called upon by the control process 113 to retrieve the off-line payment information that is forwarded to the payment server 23 for processing. In this manner, the secondary data server 116B and the secondary data 118B serve as a backup of replicated off-line data in the primary data 118A controlled by the primary data server 116A. If the secondary data server 116B is not online (decision 376), the control process 113 goes to the error state 208 (step 378) since neither the primary data server 116A nor the secondary data server 116B are available to communicate the off-line payment information to the payment server 23. If the secondary data server 116B is online, the control process 113 retrieves data from the secondary data server 116B and sends off-line payment information to the payment server 23 for processing (step 380). The control process 113 then waits for an acknowledgement to be received from the payment server 23 of off-line payment information being processed (decision 382). If the acknowledgement is not received, the control process 113 determines that the payment server 23 is off-line (decision 384), and the control process 113 will continue to attempt to send the off-line payment information to the payment server 23 for processing by returning back to step 380. If the payment server 23 was off-line in decision 384, the control process 113 goes to the off-line state 206 (step 386). Once the acknowledgment has been received from the payment server 23 of the off-line payment information having been processed, the control process 113 calls upon the data servers 116A, 116B to delete the off-line payment information in the primary data 118A and secondary data 118B (step 380). Then, if more stored off-line payment information is present to be processed, which has been previously unprocessed by the payment server 23 (decision 390), the process returns to decision 360. Otherwise, the process ends (step 392).

Note that the control process 99, 111, 113 may be a separate process from the distributed data services 110, replication data service 112, and/or primary/secondary servers 116A, 116B, or integrated within. One control process 99, 111, 113 may execute on one of the forecourt payment devices 12, 18, 28, 30, 40, or more than one control process 99, 111, 113 may execute on more than one of the forecourt payment devices 12, 18, 28, 30, 40 and still be within the spirit and scope of the invention. Those skilled in the art will recognize improvements and modifications to the preferred embodiments of the present invention. All such improvements and modifications are considered within the scope of the concepts disclosed herein and the claims that follow.

What is claimed is:

1. A peer-to-peer data replication system for off-line transactions in a fueling environment, comprising:
a plurality of forecourt devices each coupled to a local memory and each adapted to receive payment information for carrying out a transaction, wherein the plurality of forecourt devices store the payment information in their local memory;
a payment server communicatively coupled to the plurality of forecourt devices via a communication network, wherein the plurality of forecourt devices communicate the payment information to the payment server over the communication network for payment processing when the payment server is online; and
wherein the plurality of forecourt devices communicate the payment information over the communication network wherein at least one of the other plurality of forecourt devices back-up stores the payment information in the local memory as off-line payment information when the payment server is off-line.

2. The system of claim 1, wherein the plurality of forecourt devices are devices comprised from the group consisting of a fuel dispenser, a quick serve restaurant, a car wash, a site controller, and a convenience store.

3. The system of claim 2, wherein one or more of the plurality of forecourt devices execute a control process to store and receive the off-line payment information from back-up store in the local memory from another of the plurality of forecourt devices.

4. The system of claim 3, wherein the control process determines if the payment server is back online before storing the off-line payment information in the local memory.

5. The system of claim 4, wherein the control process communicates the off-line payment information to the payment server for payment processing if the payment server is back online.

6. The system of claim 4, wherein the control process communicates all of the off-line payment information stored in the local memory to the payment server for payment processing if the payment server is back online.

7. The system of claim 6, wherein the control process deletes the back-up store of the off-line payment information in the local memory if the payment server successfully processes the off-line payment information.

8. The system of claim 2, wherein each of the plurality of forecourt devices execute a replication data service that receives the off-line payment information from another of the plurality of forecourt devices for storage in replication data store associated with the replication data service.

9. The system of claim 8, wherein the replication data store is part of the local memory.

10. The system of claim 8, wherein the replication data store is memory separate from the local memory.

11. The system of claim 9, wherein a control process executing in one or more of the plurality of forecourt devices determines if the payment server is back online before storing the off-line payment information in the replication data store.

12. The system of claim 11, wherein the control process communicates the off-line payment information to the payment server for payment processing if the payment server is back online.

13. The system of claim 11, wherein the control process communicates all of the off-line payment information stored in the local memory to the payment server for payment processing if the payment server is back online and deletes all of the off-line payment information stored in the replication data service.

14. The system of 12, wherein the control process executes a voting scheme to determine which of the replication data stores contains correct off-line payment information on startup of the control process to refresh the local memory with correct off-line payment information of the plurality of forecourt devices.

15. The system of claim 14, wherein only the correct off-line payment information is communicated to the payment server for payment processing.

16. The system of claim 2, wherein one of the plurality of forecourt devices executes a primary data server coupled to a primary data and another of the plurality of forecourt devices executes a secondary data server coupled to a secondary data, wherein a control process executing in one or more of the plurality of forecourt devices causes both the primary and secondary data servers to receive the off-line payment information for back-up store in primary data and secondary data from one of the plurality of forecourt devices.

18. The system of claim 17, wherein the primary and secondary data servers are part of the local memory.

19. The system of claim 17, wherein the primary and secondary data is memory separate from the local memory.

20. The system of claim 17, wherein the control process determines if the payment server is back online before causing the primary data server and secondary data server to back-up store the off-line payment information in the primary data and secondary data, respectively.

21. The system of claim 20, wherein the control process communicates the off-line payment information to the payment server for payment processing if the payment server is back online.

22. The system of claim 20, wherein the control process communicates all of the off-line payment information to the payment server for payment processing if the payment server is back online.

23. The system of claim 22, wherein the control process causes the primary data server to delete the back-up store of the off-line payment information in primary data if the payment server successfully processes the off-line payment information.

24. The system of claim 23, wherein the control process refreshes the local memory with correct off-line payment information from the primary data on startup of the control process.

25. The system of claim 20 wherein if the primary data server is off-line, the control process determines if the payment server is back online before causing the secondary data server to back-up store the off-line payment information in the secondary data.

26. The system of claim 25, wherein the control process causes the secondary data server to delete the back-up store of the off-line payment information in secondary data if the payment server successfully processes the off-line payment information and the primary data server is off-line.

27. The system of claim 25, wherein the control process refreshes the local memory with correct off-line payment information from the secondary data store on startup of the control process if the primary data server is off-line.

28. A method of replication data for off-line transactions in a fueling environment, comprising:
receiving payment information at a forecourt device among a plurality of forecourt devices for carrying out a transaction, wherein each of the plurality of forecourt devices are communicatively coupled to a communication network;
communicating the payment information to a payment server for payment processing over the communication network; and
if the payment server is off-line:
storing the payment information in local memory coupled to the forecourt device as off-line payment information; and
communicating the off-line payment information to at least one of the other plurality of forecourt devices to back-up store the off-line payment information in the local memory.

29. The method of claim 28, further comprising executing a control process within one or more of the plurality of forecourt devices and executing a dedicated distributed data service within each of the plurality of forecourt devices to receive the off-line payment information from the control process for back-up store in the local memory from another of the plurality of forecourt devices.

30. The method of claim 29, further comprising determining if the payment server is back online before back-up storing the off-line payment information in the local memory.

31. The method of claim 30, further comprising communicating the off-line payment information to the payment server for payment processing if the payment server is back online.

32. The method of claim 30, further comprising communicating all of the off-line payment information stored in the local memory to the payment server for payment processing if the payment server is back online.

33. The method of claim 32, further comprising deleting the back-up store of the off-line payment information in the local memory if the payment server successfully processes the off-line payment information.

34. The method of claim 29, further comprising each of the plurality of forecourt devices executing a replication data service that receives the off-line payment information for back-up store in replication data store from another of the plurality of forecourt devices.

35. The method of claim 34, further comprising determining if the payment server is back online before back-up storing the off-line payment information in the replication data store.

36. The method of claim 34, further comprising communicating the off-line payment information to the payment server for payment processing if the payment server is back online.

37. The method of claim 35, further comprising communicating all of the off-line payment information to the payment server for payment processing if the payment server is back online.

38. The method of claim 37, further comprising deleting the back-up store of the off-line payment information in the replication data store if the payment server successfully processes the off-line payment information.

39. The method of claim 36, further comprising executing a voting scheme to determine which of the replication data stores contains correct off-line payment information to refresh the local memory with correct off-line payment information of the plurality of forecourt devices.

40. The method of claim 39, further comprising only communicating the correct off-line payment information to the payment server for off-line payment processing.

41. The method of claim 28, further comprising:
executing a primary data server on one of the plurality of forecourt devices wherein the primary data server is coupled to primary data;
executing a secondary data server on one of the plurality of forecourt devices wherein the secondary data server is coupled to secondary data; and
a control process executing on one or more of the forecourt devices causing both the primary and secondary data servers to receive the off-line payment information for back-up storing in the primary data and the secondary data from one of the plurality of forecourt devices.

42. The method of claim 41, further comprising the control process determining if the payment server is back online before causing the primary data server and the secondary data server to back-up store the off-line payment information in the primary data and secondary data, respectively.

43. The method of claim 42, further comprising the control process communicating the off-line payment information to the payment server for payment processing if the payment server is back online.

44. The method of claim 42, further comprising the control process communicating all of the off-line payment information to the payment server for payment processing if the payment server is back online.

45. The method of claim 44, further comprising the control process causing the primary data server to delete the back-up store of the off-line payment information in the primary data if the payment server successfully processes the off-line payment information.

46. The method of claim 44, further comprising refreshing the local memory with correct off-line payment information from the primary data on startup of the control process.

47. The method of claim 42, further comprising wherein if the primary data server is off-line, the control process determining if the payment server is back online before back-up storing the off-line payment information in the secondary data.

48. The method of claim 43, wherein the control process communicates the off-line payment information to the payment server for payment processing if the payment server is back online and the primary data server is off-line.

49. The method of claim 43, further comprising the control process communicating all of the off-line payment information to the payment server for payment processing if the payment server is back online and the primary data server is off-line.

50. The method of claim 49, further comprising the control process causing the secondary data server to delete the back-up store of the off-line payment information in the secondary data if the payment server successfully processes the off-line payment information and the primary data server is off-line.

51. The method of claim 49, further comprising refreshing the local memory with correct off-line payment information from the secondary data on startup if the primary data server is off-line.
